(19) United States
(12) Patent Application Publication
(10) Pub. No.: US 2019/0059569 A1
(43) Pub. Date: Feb. 28, 2019

(54) PET TOOTHBRUSH

(71) Applicant: SHOWAI RAKU, New York, NY (US)

(72) Inventor: SHOWAI RAKU, New York, NY (US)

(21) Appl. No.: 15/685,256

(22) Filed: Aug. 24, 2017

(51) Int. Cl. A46B 11/00; A61D 5/00

(52) U.S. Cl. CPC A46B 11/002; A46B 2200/1086; A46B 11/0062; A61D 5/00

(57) ABSTRACT

A pet toothbrush includes a hybrid brush head populated by both stiffer plastic bristles and softer TPE bristles, a brush handle and a connecting neck connecting the brush head and the brush handle. A toothpaste tube accommodates pet toothpaste. A toothpaste outlet is provided in the vicinity of the brush head. The connecting neck is provided with a toothpaste channel connected with the toothpaste outlet. The connection between the connecting neck and the brush handle is provided with a one-way delivery valve of toothpaste from the toothpaste tube to the toothpaste channel and then extruded from the toothpaste outlet. The toothbrush can continuously squeeze the toothpaste by way of a push cap or button to ensure the cleaning effect. The toothbrush has replaceable brush heads. The toothpaste outlet can be closed to maintain toothbrush cleanliness.

### BACKGROUND OF THE INVENTION

### 1. Field of the Invention

The invention generally relates to toothbrushes, and, more specifically, to a pet toothbrush.

### 2. Description of the Prior Art

At present, with the improvement of living standards, pets are becoming more and more common in people's lives. They have become an important part of life. So, the hygiene of pets is becoming more and more important, especially the oral hygiene of pets. Currently, cleaning the mouth of a pet requires the use of an ordinary toothbrush. However, pet toothpaste generally has the taste of meat. When attempting to brush their teeth pets will tend to swallow the toothpaste before it is applied to the teeth, so the use of ordinary toothbrushes cannot achieve the desired cleaning effect. Repeated applications of toothpaste to continue the cleaning process is inefficient and tedious.

### SUMMARY OF THE INVENTION

The toothbrush in accordance with the invention is designed to overcome the above problems. More specifically, a pet toothbrush in accordance with the invention comprises a brush head, a brush handle and a connecting neck connecting the brush head and the brush handle, wherein the handle is provided with a toothpaste tube for receiving pet toothpaste. There is provided a toothpaste outlet connected to a toothpaste channel in a connecting neck supported by a handle to allow toothpaste to be conveyed from a toothpaste cartridge within the handle to the toothpaste outlet and from the toothpaste outlet and selectively extruded through a unidirectional delivery assembly.

Furthermore, the unidirectional delivery assembly includes an assembly housing, a flexible pressing bladder, a bladder support, a push cap or button, a compression bracket, a closing bracket and a one-way valve, one end of which is fixed to the connecting neck. The pressing bladder comprises a sleeve-like capsule having a capsule tube or neck communicating the capsule with the toothpaste channel. The open end of the capsule is directed towards the opening of a toothpaste cylinder and is sealingly connected to the opening of the toothpaste cylinder. A one-way valve is provided at the opening of the toothpaste cylinder. The pressing bracket is a semicircular ring around the capsule body, and both ends of the pressing bracket are provided with elasticity for resetting between the two ends of the pressing frame and the capsule body or the module shell. The push cap or button is provided on the side of the pressing frame opposite to the elastic member, and the push cap projects out of the module case. The closing bracket is a U-shaped frame which is pivotally connected to the bladder support on both sides, the pressing bracket being capable of pressing the two ends of the closing bracket to rotate the closing bracket so that the bottom end of the closing bracket presses the bladder tube or neck to stop and prevent the delivery of the toothpaste to the toothpaste channel.

Further, the toothpaste cylinder or cartridge includes a barrel and an opening provided at an end of the barrel body. The body of the barrel is provided with a sliding disc or piston, and a sliding seal is provided between the sliding disc or piston and the inner wall of the barrel. The end of the brush handle is provided with a vent hole.

Further, the open end of the capsule is provided with a sealing flange, and the opening of the toothpaste can be fixed to the bladder support through a toothpaste fixation ring, which is provided between the opening of the capsule and the toothpaste cylinder. The check valve may be in the shape of a T-shaped bonnet through the check valve panel.

Further, at the exit point of the toothpaste there is preferably provided a tubular outlet encapsulant disposed perpendicularly to the connecting neck and in a position in proximity to the brush corresponding to the toothpaste channel on the side wall of the outlet encapsulation hole.

Compared with the prior art, the pet toothbrush in accordance with the invention described below has the following advantages:
1. Provides an easy and convenient way to brush the teeth of a pet by releasing toothpaste after the toothbrush is in the pet's mouth in proximity of the teeth and in a position to start brushing teeth;
2. Can be reused. The toothpaste, after use, can be squeezed again;
3. Easy to operate; and
4. The toothpaste outlet can be closed to ensure the cleanliness of the internal toothpaste.

### BRIEF DESCRIPTION OF THE DRAWINGS

FIG. 1 is a side elevational view of the external structure of an embodiment of a pet toothbrush in accordance to the invention;

FIG. 2 is a cross-sectional view of a sleeve-like pressing bladder used in the embodiment shown in FIG. 1;

FIG. 3 is an exploded view of the pet toothbrush shown in FIG. 1;

FIG. 4 is a partial exploded view of the pet toothbrush shown in FIG. 1 illustrating the operative components for applying pressure to the bladder shown in FIG. 2;

FIG. 5 is a cross-sectional view of an operative state of the toothbrush shown in FIG. 1 when the push cap or button is pressed to dispense toothpaste;

FIG. 6 is a partial exploded view similar to FIG. 4 in a reset state after the push cap or button is released;

FIG. 7 is a cross-sectional view similar to FIG. 5 in a reset state after the push cap or button is released;

FIG. 8 is an enlarged cross-sectional view of a detail in FIG. 5 showing a closing bracket in a position on the bladder tube or neck to cut off flow of toothpaste;

FIG. 9 is a schematic view showing the handle containing the toothpaste cylinder separated from the module case or assembly housing;

FIG. 10 is a rendering, in cross-section, of another embodiment of a pet toothbrush in accordance with the invention;

FIG. 11 is a side elevational view of still another embodiment of a pet toothbrush in accordance to the invention;

FIG. 12 is a cross-section of a pet toothbrush shown in FIG. 11 in a state prior to application of force on the push cap or button;

FIG. 13 is an exploded view similar to FIG. 3 of the toothbrush shown in FIGS. 11 and 12;

FIG. 14 is an enlarged cross-sectional detail of the toothbrush shown in FIG. 12 with the push cap or button in an extended position prior to application of a manual force urging the push cap or button inwardly;

FIG. 15 is similar to FIG. 14 but shows the push cap or button in a retracted position to press or deform the flexible bladder;

FIG. 16 is similar to FIG. 9 for the embodiment shown in FIGS. 11-15.

FIG. 17 is an enlarged perspective distal end view of the brush head shown in FIG. 11 while attached to the neck of the tooth brush;

FIG. 18 is a perspective view of the brush head shown in FIG. 17 from an opposing proximal end when detached from the neck of the toothbrush; and

FIG. 19 is a perspective view of the toothbrush of FIGS. 11-18 showing the connecting neck disengaged from the brush head.

### DETAILED DESCRIPTION

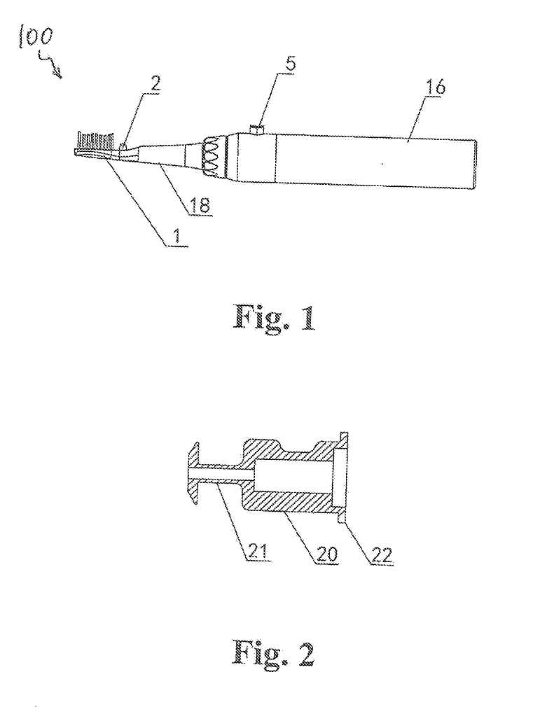

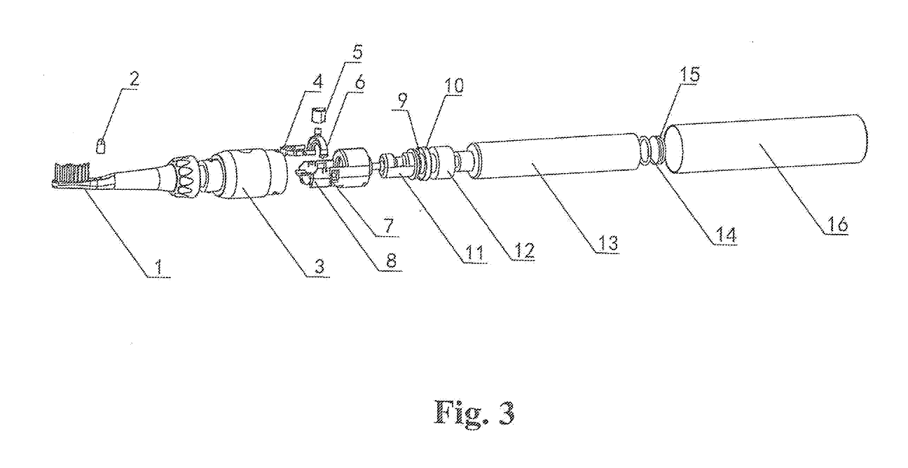

Referencing specifically to the drawings, and first referring to FIGS. 1 to 3, an insulative pet toothbrush 100 includes a brush head 1 and a brush handle 16. A connecting neck 18 connects the brush head 1 and the handle 16. There is provided a toothpaste cylinder 13 for receiving pet toothpaste. A toothpaste outlet or passage 19 is provided within the neck 18 that extends to the vicinity of the brush head 1. Connected to the toothpaste outlet is a one-way conveying assembly or valve capable of delivering toothpaste one-way from the toothpaste cylinder 13 to the toothpaste passage 19 and then extruded from the toothpaste outlet. The brush head 1 and the connecting neck 18 may be integrally formed and can be replaced.

A unidirectional delivery assembly includes an assembly housing 3, a flexible pressing bladder or sleeve-like capsule 11, a bladder support 8, a push cap 5 or button, a pressing bracket 6, a closing bracket 4 and a check valve 9. A holding or supporting plate 10 maintains the check valve 9 in place. The module housing 3 is connected to the neck 18 with the other end fixed to the handle 16, which comprises a sleeve-like bladder 20 and a bladder neck or tube 21 for communicating the bladder 20 with the toothpaste passage 19. The open end of the bladder 20 faces the toothpaste cylinder 13. The opening of the bladder 20 has a sealing flange 22 that is sealed and connected to the opening of the toothpaste cylinder 13. The pressing bracket 6 is a semi-circular ring around the bladder body 20. An elastic restoring member 7 is provided between both ends of the pressing bracket 6 and the bladder carrier or support 8 or the module or assembly housing 3, which is provided on the side of the pressing bracket 6 opposite to the elastic member 7 and presses the cap 5. The closing bracket 4 is a U-shaped frame which is pivotally connected to the bladder support or frame 8 on both sides. The pressing or compression bracket 6 can press both ends of the closing bracket 4 to rotate the bracket 4 when pressed so that the bottom end of the closed stent 4 presses the bladder 21, thereby stopping the delivery of the toothpaste to the toothpaste outlet or passageway 19. A seesaw overall frame structure. The elastic member 7 is a spring although any other restoring member may be used. The pressing bladder 11 is made of an elastic material such as rubber.

The toothpaste cylinder or canister 13 includes a can or other tubular barrel body. An opening is provided at an end of the barrel body. A sliding disc or piston 15 is provided inside the barrel body, and a sliding seal 14 is provided between the sliding disc or piston 15 and the inner wall of the barrel. The bottom portion of the handle 16 is provided with a vent hole 17.

As shown in FIG. 2 the opening end of the capsule bladder body 20 is provided with a sealing flange 22. The opening of the toothpaste cylinder 13 is fixed to the bladder holder or support 8 through a toothpaste fixation ring 12 provided in the capsule body 20. The toothpaste is provided between the openings of the cylinder 13 and the check valve 9.

The mouth of the toothpaste outlet or passageway is provided with a tubular outlet nipple or outlet valve knob 2 disposed in proximity to the brush head 1 and perpendicularly to the connecting neck 18. The nipple 2 can be rotated, so that the connection hole does not communicate with the toothpaste channel 19 to ensure that the internal toothpaste hygiene remain clean.

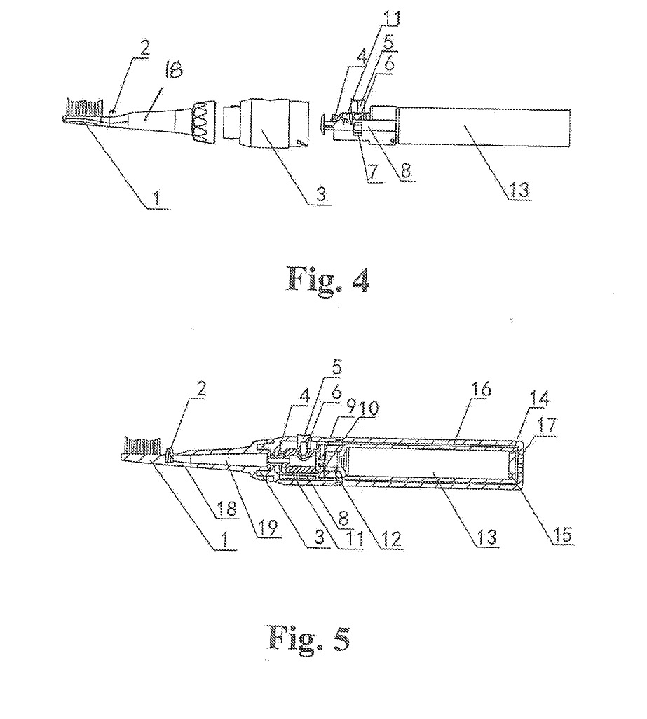

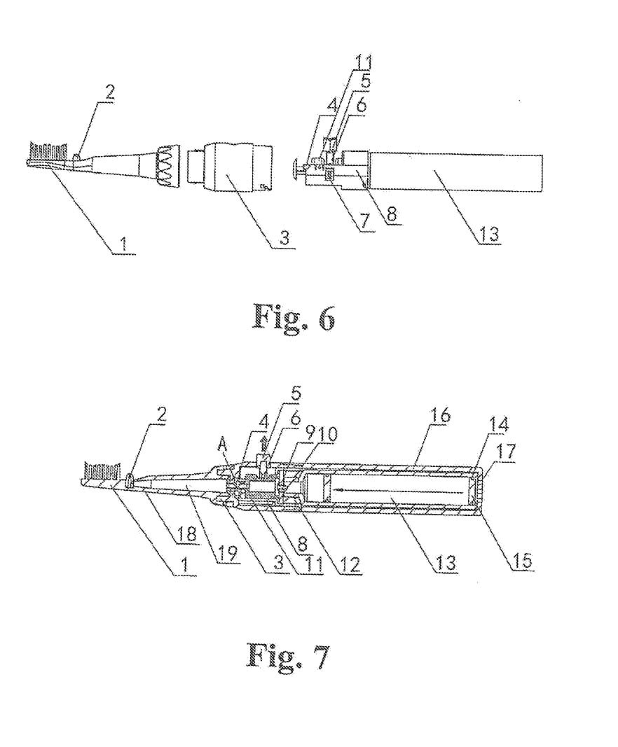

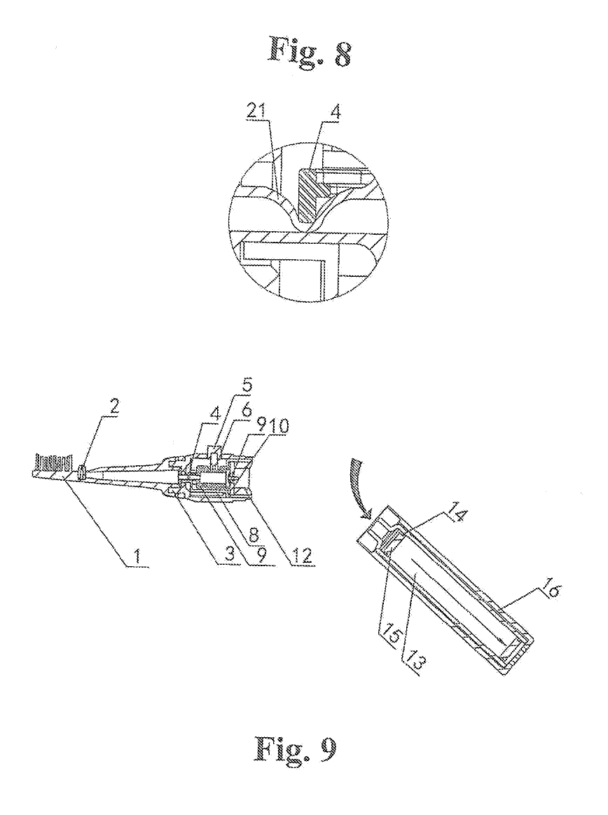

As shown in FIGS. 4 to 8, when the pressing frame or compression bracket 5 is pressed by pressing the push cap or button 5, the bladder 11 is depressed and this presses the inside of the bladder 11. When the cap or button 5 is released, it expands under the action of the elastic member 7, and the bladder 11 is returned to the initial condition by the elasticity of the elastic member 7. The closed holder or bracket 4 presses the neck or tube 21 of the bladder 20 to close it, and the check valve 9 is opened by the atmospheric pressure. The toothpaste in the toothpaste cylinder 13 is urged into the pressing or flexible bladder 11. Pressing the push cap or button 5 presses the check valve 9 to close. The closing bracket 4 is opened, pressing the flexible bladder 11 to urge the toothpaste to be extruded through the toothpaste channel or passageway 19. The operation is repeated until sufficient toothpaste is extruded from the toothpaste outlet. While the toothpaste continues to press forward, the sliding backsheet disc or piston 15 slides forward with the sliding seal 14 under the action of atmospheric pressure. The sliding seal 14 ultimately abuts against the inner wall of the handle 16 to ensure that the toothpaste is squeezed clean.

As shown in FIG. 9, after the toothpaste in the toothpaste cylinder 13 is depleted, the handle 16 may be detached from the module case or assembly housing 3 and new toothpaste can be squeezed into the toothpaste cylinder 13. During this time, the sliding disc or piston 15 with the seal 14 slide rearwardly to the bottom or rear of the toothpaste cylinder indicated by the arrow in FIG. 9 to achieve recycling.

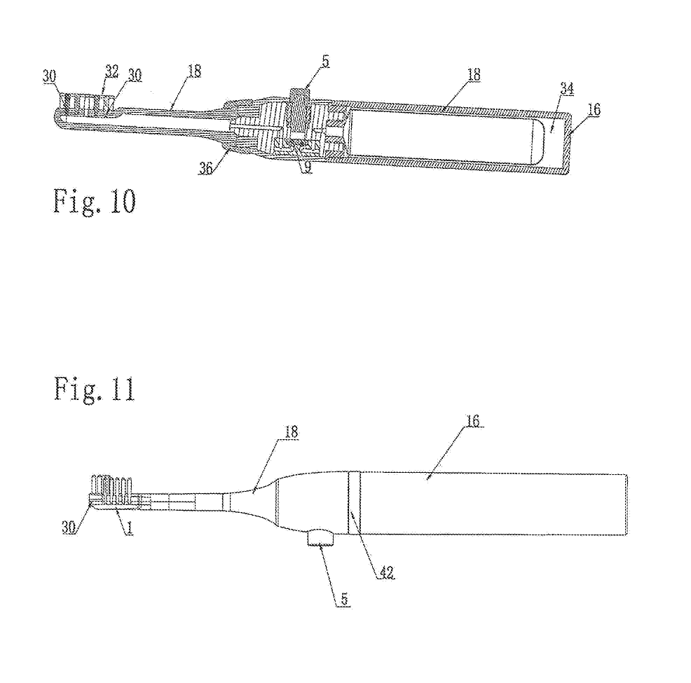

Referring to FIG. 10 an alternate design or embodiment 100′ of the invention is shown. The toothbrush 100′ shares many features with the first-described embodiment 100. However, the brush head 1 is provided with one or more holes 30 instead of the outlet nipple 2. Preferably, a plurality of holes 30 are provided extending from the outlet passageway 19 in the neck 18 and opening in the regions between the bristles 32 of the brush head 1 to dispense toothpaste from the inside instead of applying it to the top of the bristles. This will avoid toothpaste being lapped up because the pet toothpaste is normally pleasantly flavored to induce pets to having their teeth brushed.

At the bottom or rear of the handle 16′ there is advantageously provided any conventional Bluetooth unit or module 34 than can communicate with an APP on the pet owner's cell phone to provide reminders of when to brush the pet's teeth and also keep a record of teeth brushings.

The neck 18 of the head may be attached to the housing by means of mating screw threads 36. Also, the push cap or button 5 forms part of a modified pump with a one way valve. However, the specific pump and valves used are not critical and any such components that can undirectionally advance toothpaste from the toothpaste cylinder to and beyond the neck 18 into proximity with the bristles when the push cap or button 5 is depressed may be used.

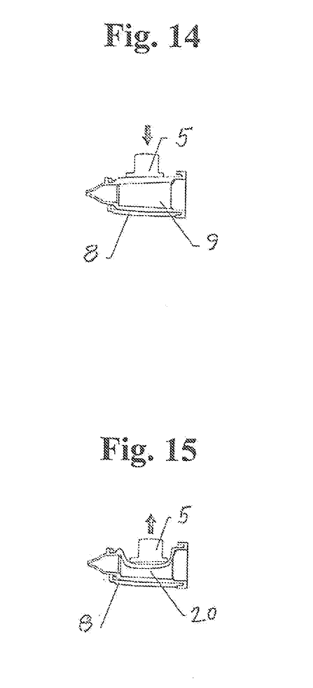

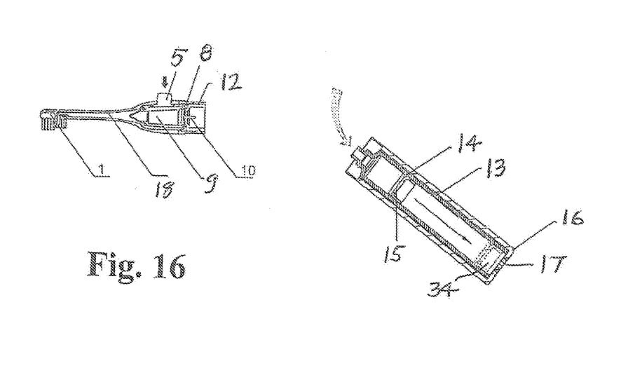

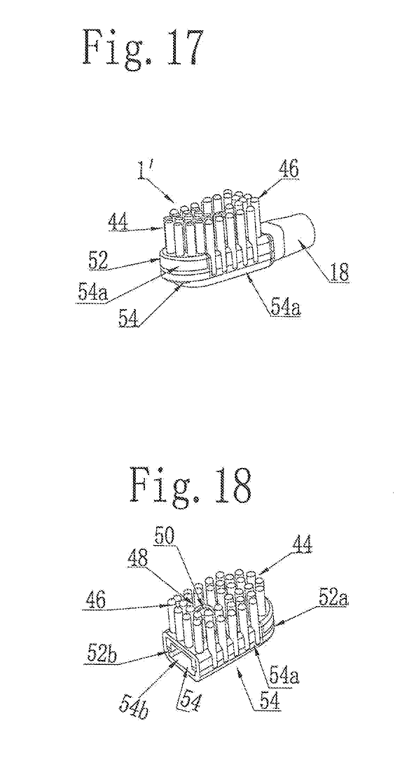

Referring to FIGS. 11-19 still another alternate design or embodiment 100″ is shown. An important feature of the toothbrush 100″ is that it utilizes a hybrid brush head 1′ to be described more fully in connection with FIGS. 17-19.

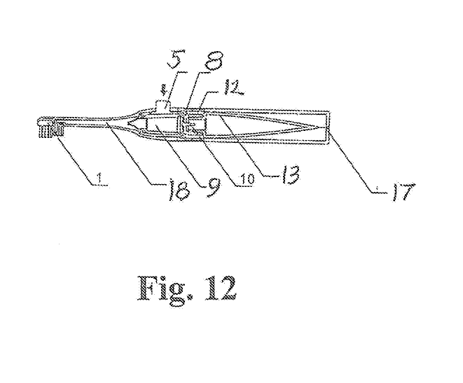

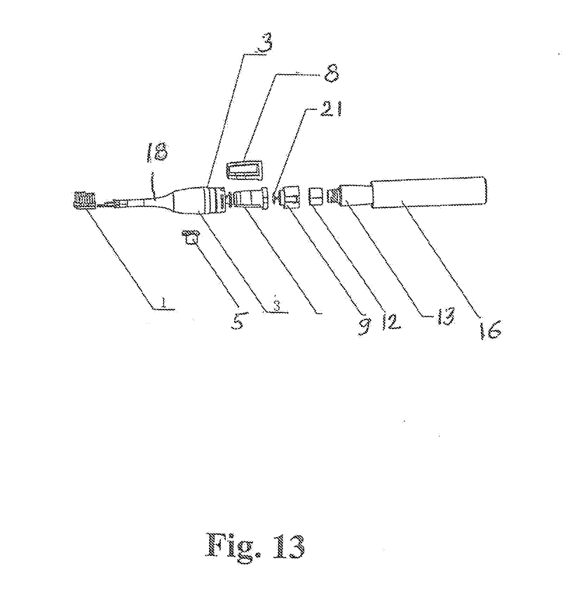

Referring to FIG. 13 a collapsible toothpaste tube 13′ is provided with a neck 13″ that receives a nozzle 40 (FIG. 12). The modified bladder 20′ feeds toothpaste through the nozzle 40 from the collapsible toothpaste tube 13′ through the hollow neck 18 to the brush head 1′. Referring to FIG. 7 a decorative ring 42 may be provided.

Referring to FIGS. 17 and 18, the brush head 1′ includes both conventional or traditional plastic bristles 44 and thermoplastic elastomer (TPE) bristles 46. The plastic bristles 44 are longer than the TPE bristles 46, as best shown in FIG. 18. Provided at a location substantially central to the brush head 1′ is a tubular member 48 that communicates with the channel or passageway 19 within the neck 18 for selectively extruding toothpaste through a nozzle 50. The plastic bristles 44 are embedded within a plastic base or platform 52 provided with a rounded end 52a as shown in FIG. 17 and a generally U shaped cross section 52b best shown in FIG. 18. A feature of the brush head 1′ is that the TPE bristles are integrally formed on an over-molded layer 54 that substantially capsulates the plastic base or platform 52 except for the rounded leading end 52a. The over-molded layer 54 includes lateral layer portion 54a and a bottom layer 54b (FIG. 18) that forms, together with the U-shaped portion 52b, a recess or channel 56 for receiving a tab or tongue 58 on the neck 18 that can, for example, be slidably inserted within the recess or channel 56 and held in place by frictional engagement or other interlocking method.

The hybrid tooth brush head 1′ provides functionality of cleaning the surfaces of teeth, the TPE bristles 46 spreading the toothpaste on the pet's teeth to more gently clean the surfaces of the teeth while the plastic bristles 44 are stiffer for more effectively removing tartar and plaque. The brush head 1′ is, therefore, easily separated from the neck 18 and replaced as may be needed.

The benefits of the pet toothbrush in accordance with the invention include Bluetooth functionality that is interactive with owners and pet care givers that helps collect tooth-brushing data and provides reminders when the pet's teeth should be brushed.

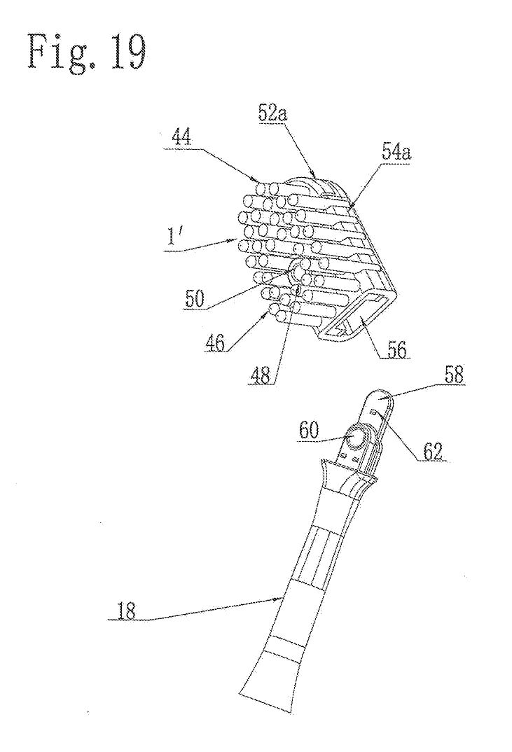

Referring to FIG. 19 the brush head 1′ is shown separated from the neck portion 18 of the toothbrush. Located at the distal end of the neck 18 is a tab or tongue 58 that projects longitudinally from the neck 18, a portion thereof being provided with an aperture 60 that is in fluid flow communication with the internal channel of the neck or passageway 19. The tab or tongue 58 may also be provided with a protuberance 62 dimensioned and configured to provide a snap or interference fit with the recess or channel 56 to retain the brush head 1′ connected to the neck 18 during normal use.

It is also contemplated that the brush head be selectively connected or disconnected with the neck 18 and/or the housing to allow easy and convenient replacement of the brush head at minimal cost when the bristles are not longer suitable for use.

The main advantages differentiating the pet toothbrush from existing brushes include:
1. Brushing the teeth of pets without paste being lapped up and maintaining a pet's teeth health.
2. The heads are replaceable, saving cost and maintaining hygiene.
3. Interaction with owners of pets, encouraging owners to keep good habits of brushing the teeth of their pets.
4. Facilitating soft-packaged tooth paste that fits within the Paste Chamber.
5. People can easily use it by simply putting the customized paste into the Past Chamber. Not only will it benefit users, it also saves packaging costs of brush pastes and environmentally-friendly.
6. Improving owners' awareness of their loved furry friends dental health that play a very important role of prolonging their longevity and improving their living standards.
7. Environmental friendly product (replaceable toothbrush's head, may be soft-packaged toothpaste).

The above description is only a preferred embodiment of the utility model. However, the scope of the present invention is not limited thereto, and any technical person skilled in the art is disclosed in the utility model within the scope of protection of the utility model, within the scope of the present invention, within the scope of the present invention, in accordance with the technical solutions and inventive concepts of the utility model.

1. A pet toothbrush comprising a brush head; a brush handle and a connecting neck connecting said brush head and said brush handle, said handle being configured to received a toothpaste tube containing pet toothpaste, a toothpaste outlet being provided in the vicinity of said brush head, and said connecting neck being provided with a toothpaste channel connected with said toothpaste outlet, and the connection between the connecting neck and the brush handle is provided with one way valve means for allowing flow of toothpaste in only one direction from said toothpaste tube to said toothpaste channel to be extruded from said toothpaste outlet, said brush head being a hybrid brush head including both plastic bristles and thermoplastic elastomer (TPE) bristles.

2. A pet toothbrush according to claim 1, wherein said TPE bristles are shorter than said plastic bristles.

3. A pet toothbrush according to claim 1, wherein said toothpaste outlet is arranged to dispense toothpaste within a region populated by said TPE bristles.

4. A pet toothbrush according to claim 1, wherein said brush head comprises a plastic base or platform populated by said plastic bristles.

5. A pet toothbrush according to claim 4, wherein said plastic bristles are arranged on a leading or distal end of said brush head and said TPE bristles are arranged on a trailing or proximate end of said brush end.

6. A pet toothbrush according to claim 1, wherein said brush head is selectively attachable to and separatable from said connecting neck.

7. A pet toothbrush according to claim 6, wherein retaining means secures said brush head to said connecting neck during use and allows manual separation said brush head from said connecting neck.

8. A pet toothbrush according to claim 7, wherein said brush head has a receiving recess or cavity and said neck has a mating tab or tongue dimensioned to be received within said recess or cavity.

9. A pet toothbrush according to claim 8, wherein said retaining means comprises dimensions of said recess or cavity and said tab or tongue to provide a friction fit there between.

10. A pet toothbrush according to claim 8, wherein said retaining means comprises a depression on a surface of said recess or cavity and a protuberance on said tab or tongue arranged to be coextensive with said depression when said tab or tongue is fully inserted into said recess or cavity to provide a snap fit.

11. A pet toothbrush according to claim 4, wherein said TPE bristles are over molded over said plastic base or platform.

12. A pet toothbrush according to claim 1, further comprising Bluetooth means for communicating with a pet owner's portable device loaded with an APP to provide notification of at least one of reminders for teeth brushings, records or logs of teeth brushings and timers for durations of teeth brushings.

13. A pet toothbrush comprising a brush head; a brush handle and a connecting neck connecting said brush head and said brush handle, said handle being configured to received a toothpaste tube containing pet toothpaste, a toothpaste outlet being provided in the vicinity of said brush head, and said connecting neck being provided with a toothpaste channel connected with said toothpaste outlet, and the connection between the connecting neck and the brush handle is provided with one way valve means for allowing flow of toothpaste in only one direction from said toothpaste tube to said toothpaste channel to be extruded from said toothpaste outlet, said brush head being a hybrid brush head including both plastic bristles and thermoplastic elastomer (TPE) bristles, said brush head being selectively attachable to and separatable from said connecting neck.

14. A pet toothbrush according to claim 13, wherein said brush head is selectively attachable to and separatable from said connecting neck.

15. A pet toothbrush according to claim 14, wherein retaining means secures said brush head to said connecting neck during use and allows manual separation said brush head from said connecting neck.

16. A pet toothbrush according to claim 15, wherein said brush head has a receiving recess or cavity and said neck has a mating tab or tongue dimensioned to be received within said recess or cavity.

17. A pet toothbrush according to claim 16, wherein said retaining means comprises dimensions of said recess or cavity and said tab or tongue to provide a friction fit there between.

18. A pet toothbrush according to claim 17, wherein said retaining means comprises a depression on a surface of said recess or cavity and a protuberance on said tab or tongue arranged to be coextensive with said depression when said tab or tongue is fully inserted into said recess or cavity to provide a snap fit.

19. A pet toothbrush according to claim 13, further comprising Bluetooth means for communicating with a pet owner's portable device loaded with an APP to provide notification of at least one of reminders for teeth brushings, records or logs of teeth brushings and timers for durations of teeth brushings.

20. A pet toothbrush comprising a brush head; a brush handle and a connecting neck connecting said brush head and said brush handle, said handle being configured to received a toothpaste tube containing pet toothpaste within said handle, a toothpaste outlet being provided in the vicinity of said brush head, and said connecting neck being provided with a toothpaste channel connected with said toothpaste outlet, and the connection between the connecting neck and the brush handle is provided with one way valve means for allowing flow of toothpaste in only one direction from said toothpaste tube to said toothpaste channel to be extruded from said toothpaste outlet, said brush head being a hybrid brush head including both plastic bristles and thermoplastic elastomer (TPE) bristles.
